(19) United States
(12) Patent Application Publication
(10) Pub. No.: US 2011/0121996 A1
(43) Pub. Date: May 26, 2011

(54) Method and System for Detecting an Occupant Using Reflected Signals

(75) Inventors: Dennis P. Griffin, Noblesville, IN (US); Mark C. Hansen, Kokomo, IN (US)

(73) Assignee: DELPHI TECHNOLOGIES, INC., Troy, MI (US)

(21) Appl. No.: 12/623,644

(22) Filed: Nov. 23, 2009

(51) Int. Cl. G08G 1/04

(52) U.S. Cl. 340/943

(57) ABSTRACT

An occupant detection system emits an ultrasonic signal for detecting the presence of an occupant by reflecting the signal off the occupant and then determines that an occupant is present by detecting motion of the occupant. One type of motion that is detected is the small rhythmic motion associated with respiration. The motion detection system improves detection of motion smaller than a wavelength of the ultrasonic signal by shifting the wavelength of the ultrasonic signal to increase the detected motion signal. The system may also determine the presence of an occupant by comparing the motion signal to a motion pattern that corresponds to respiration.

### TECHNICAL FIELD OF INVENTION

The invention relates to a method for detecting an occupant by emitting first and second signals, such as ultrasonic signals, and detecting reflected signals. More particularly, this invention relates to such method wherein a reflection of the second emitted signal has a second phase difference that is shifted about 40 to about 140 degrees or about −40 to about −140 degrees relative to a first phase difference produced by a reflection the first emitted signal. The method improves detection of apparent movements smaller than one quarter wavelength, such as movements associated with respiration of an infant in an infant seat located in a vehicle.

### BACKGROUND OF INVENTION

It is known to use ultrasonic signals to detect the presence of an occupant in a vehicle. U.S. Pat. No. 6,932,769 describes a method that emits sound waves toward the seat and detects reflected sound waves. Motion is determined by analyzing a detected signal corresponding to the reflected waves. When an occupant moves, the distance traveled by the waves changes, which is detectable by a change in the relative phase difference between the emitted signal and reflected signal. This change in the phase difference is amplitude demodulated to determine a motion signal. The method works well for detecting large motion corresponding to several wavelengths, such as motion made by adult occupants. However, an infant in an infant seat may not make a motion that is readily detectable, particularly if the infant is sleeping and covered with a blanket, so that the apparent motion is limited to the respiration of the infant. If the apparent motion due to respiration movement by the infant is less than a quarter wavelength, the amplitude of the demodulated signal may be too small to reliably detect the infant.

What is needed is a method for detecting an occupant in a vehicle by emitting ultrasonic signals or the like and detecting reflected signals, and is capable of distinguishing small motions, such as the motion associated with respiration of a sleeping infant in an infant seat covered by a blanket.

### SUMMARY OF THE INVENTION

In accordance with this invention, a method for detecting an occupant in a vehicle includes emitting a first emitted signal at a first wavelength and then detecting a first reflected signal arising from a reflection of the first emitted signal. Movement by an occupant is detected by analyzing a first motion signal based on determining a first phase difference between the first reflected signal with respect to the first emitted signal, provided that a first motion signal magnitude is greater than a first threshold. If the first motion signal magnitude is less than the first threshold, a second emitted signal having a second wavelength is emitted and a second reflected signal based on the second emitted signal is detected. The wavelength of the second emitted signal is selected to produce a phase difference shift in the second phase difference relative to the first phase difference of about 40 to about 140 degrees or about −40 to about −140 degrees. The second reflected signal has a second phase difference with respect to the second emitted signal that is used to determine a second motion signal and a second motion signal magnitude. If the second motion signal magnitude is greater than a second threshold, the presence of an occupant is determined based on the second motion signal.

In another aspect, a method for detecting an occupant in a vehicle includes emitting a first emitted signal having a first wavelength and detecting a first reflected signal that is a reflection of the first emitted signal. A first modulated signal based on a phase difference of the first reflected signal relative to the first emitted signal is determined, and this first modulated signal is amplitude demodulated in order to determine a first motion signal. The first motion signal is analyzed to determine a first motion signal magnitude, and if the first motion signal magnitude is greater than or equal to a first threshold, the presence of an occupant is determined based on the first motion signal. If the first motion signal magnitude is less than a first threshold, a second wavelength distinct from the first wavelength is selected and a second emitted signal is emitted having the second wavelength. A second reflected signal arising from a reflection of the second emitted signal is analyzed. A second phase difference of the second reflected signal relative to the second emitted signal is analyzed to determine a second motion signal by amplitude demodulating the second modulated signal. The second motion signal has a second motion signal magnitude, and if the second motion signal magnitude is greater than a second threshold, the presence of an occupant is determined based on the first motion signal and the second motion signal. The selection of the second wavelength is based on being effective to produce a second nominal phase difference based on the second modulated signal that differs about 40 to about 140 degrees or about −40 to about −140 degrees from a first nominal phase difference based on the first modulated signal.

In another aspect of this invention, a system for detecting an occupant in a vehicle is provided. The system includes an emitter for emitting a first signal having a first wavelength and a detector for detecting a reflected signal arising from a reflection of the first signal. The emitter and detector are connected to a controller configured to output a first excitation to the emitter for emitting a first emitted signal having a first wavelength and to receive a first detection signal from the detector for detecting a first reflected signal based on the first emitted signal. The system determines a first phase difference of the first reflected signal with respect to the first emitted signal, and determines a first motion signal based on the first phase difference. The system also determines a first motion signal magnitude based on the first motion signal. If the first motion signal magnitude is greater than a first threshold, the system determines the presence of an occupant based on the first motion signal. If the first motion signal magnitude is less than a first threshold, the system emits a second emitted signal having a second wavelength and detects a second reflected signal based on the second emitted signal. The second reflected signal has a second phase difference with respect to the second emitted signal. The system determines a second motion signal based on the second phase difference, and a second motion signal magnitude based on the second phase difference. If the second motion signal magnitude is greater than a second threshold, the system determines the presence of an occupant based on the second motion signal. The second frequency of the second excitation signal is selected to produce a phase difference shift in the second phase difference relative to the first phase difference of about 40 to about 140 degrees or about −40 to about −140 degrees.

Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a cut-away side view of a vehicle equipped with an ultrasonic movement sensing system in accordance with this invention;

FIG. 2 is a block diagram of the ultrasonic movement sensing system in FIG. 1;

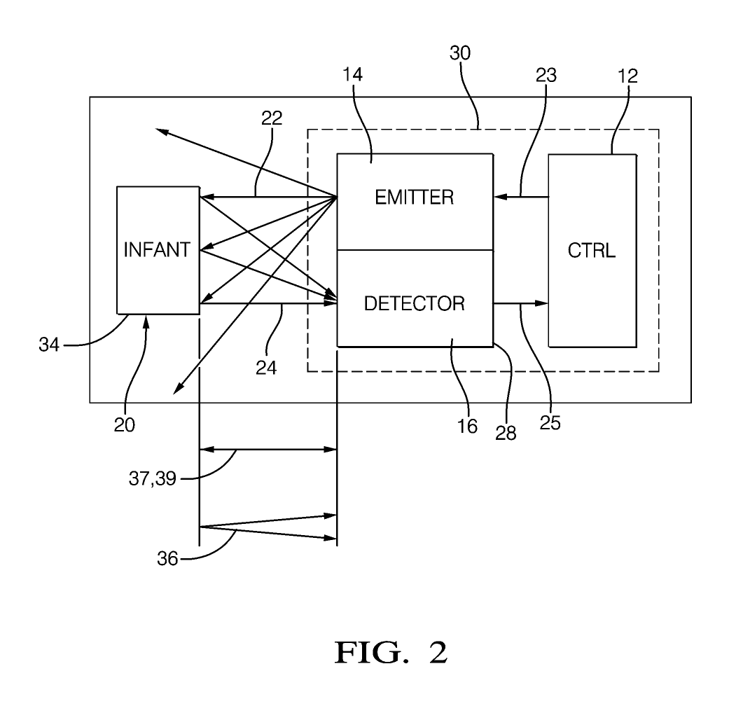

FIG. 3 is waveform diagram depicting an example of a waveform produced by the system in FIG. 1; and

FIG. 4 is a flow chart of a method for operating the ultrasonic movement sensing system in FIG. 2; and

FIG. 5 is a graph of a waveform corresponding to a respiration pattern used by the system in FIG. 1.

### DETAILED DESCRIPTION OF INVENTION

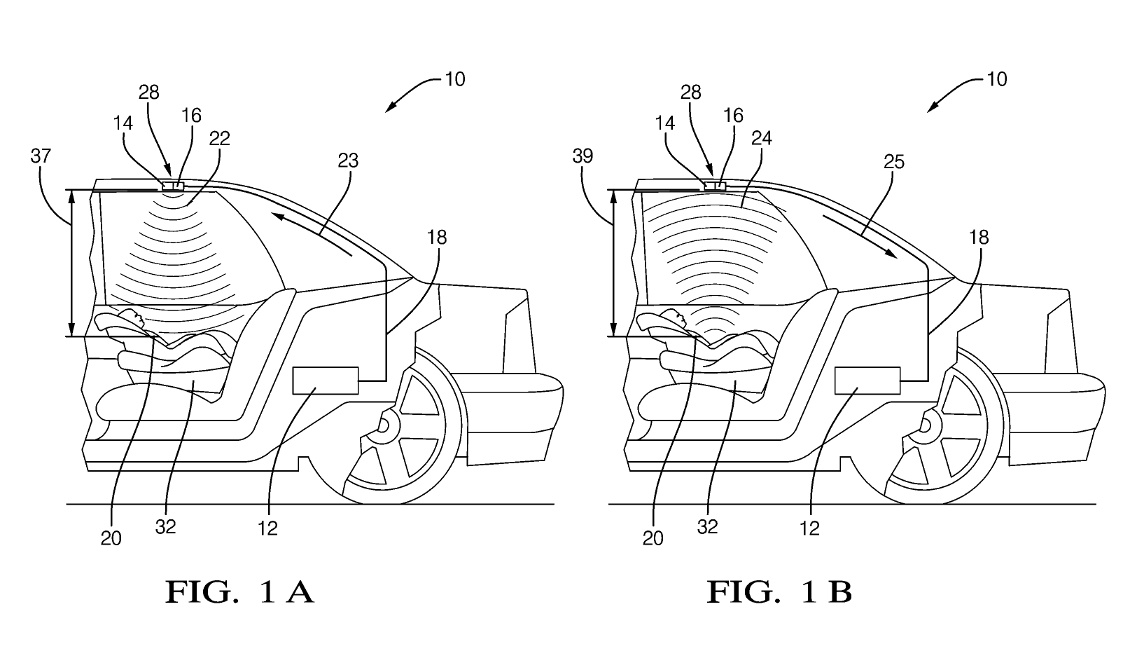

Referring to FIGS. 1A and 1B, in accordance with a preferred embodiment of this invention, a system and method are provided for use in an automotive vehicle 10 for detecting a presence of an occupant in a vehicle seat. As illustrated in the figures, the system is suitable for detecting an infant 20 carried in an infant car seat 32, also referred to as an infant car carrier, mounted in a rear seat of vehicle 10. It is an advantage of this invention that it reliably detects an infant in an infant seat based on respiration, despite the relatively small movement associated with infant respiration. Also, it is recommended practice to position an infant seat in a rear vehicle seat, when available. The method is also capable of detecting older children and adults, and may be located to detect occupants in a front seat.

The system comprises a transducer 28 for emitting ultrasonic acoustic waves toward the vehicle seat and detecting reflected ultrasonic acoustic waves. In this embodiment, transducer 28 is located in the vehicle roof overhead of the vehicle seat. The overhead location is particularly suited for directing waves toward the seat with minimal likelihood of obstruction. Moreover, it provides direct view of the infant 20 through the open top of the infant seat 32. While an overhead location is preferred, the transducer may be mounted in other locations that provide suitable access to the seat being monitored. In this embodiment, transducer 28 is preferably an ultrasonic transducer.

Ultrasonic transducers are readily commercially available and may include an emitter 14 and a detector 16 in a common housing. A suitable emitter comprises a piezoelectric element adapted to emit ultrasonic waves in response to an excitation signal such as a sinusoidal alternating electric voltage. A suitable detector includes a piezoelectric element that outputs a detection signal in response to ultrasonic waves that, in response to alternating acoustic waves, is an alternating electric voltage.

The system also includes a controller 12. The controller is connected to transducer 28 by a connection 18 that may be an electrical wire or an optical fiber. Controller 12 is adapted to output an excitation signal to the emitter 14 as indicated by arrow 23. In response to the excitation signal, emitter 14 emits acoustic waves illustrated as emitted signal 22 toward the vehicle seat. The excitation signal is characterized as having a frequency corresponding to ultrasonic signals, and emitted signal 22 is characterized as having a wavelength based on the frequency. Emitted signal 22 travels distance 37 to infant 20 and is reflected toward detector 16 as shown by reflected signal 24 if FIG. 1B. Reflected signal 24 travels distance 39 to detector 16. In response to reflected waves creating reflected signal 24, detector 16 outputs an electrical detection signal indicated by arrow 25 to controller 12. Controller 12 analyzes detection signal that corresponds to reflected signal 24 to determine occupancy of the vehicle seat.

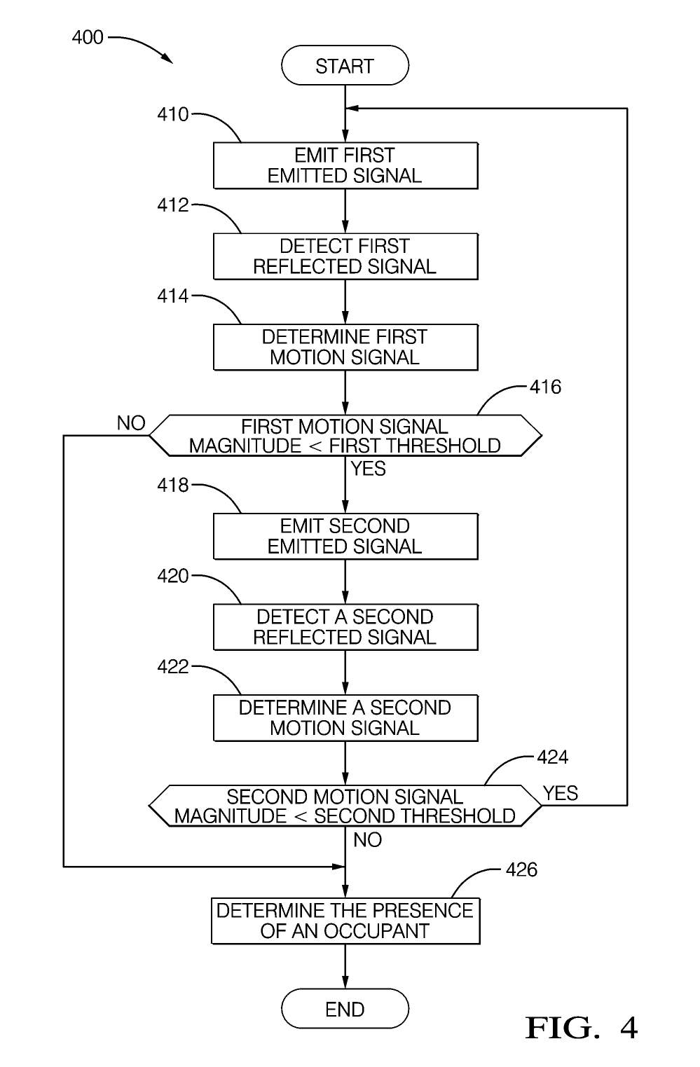

Referring to FIG. 4, a method for determining the presence of an occupant based on a detection signal arising from the reflected waves is set forth by a flowchart 400. At step 410, controller 12 outputs an excitation signal to emitter 14 to generate a first emitted signal 22. The excitation signal is preferably sinusoidal and electric, and emitted signal 22 is preferably an ultrasonic acoustic sound wave having a first wavelength. Emitted signal 22 propagates toward infant 20 and is reflected by infant 20 to generate reflected signal 24 that propagates distance 39 toward detector 16. At step 412, reflected signal 24 is detected by detector 16. In response to reflected signal 24, detector 16 outputs an electrical detection signal to controller 12. At step 414, a first motion signal is determined based on a phase difference between the excitation signal and the detection signal.

The value of the motion signal depends upon the sum of distance 37 traveled by emitted signal 22 and distance 39 traveled by reflected signal 24. At step 416, a motion signal magnitude based on an amount of variation or change in the first motion signal value is compared to a first threshold. If the first motion signal magnitude is not less than the first threshold, i.e. greater than a first threshold, then the motion signal may have sufficient magnitude to be useful for determining the presence of an occupant as indicated by the NO path going to step 426. The value of the first threshold is determined experimentally since it is dependent upon a number of factors such as the dimensions of the vehicle interior, materials used in the vehicle interior, and various operational characteristics of transducer 28.

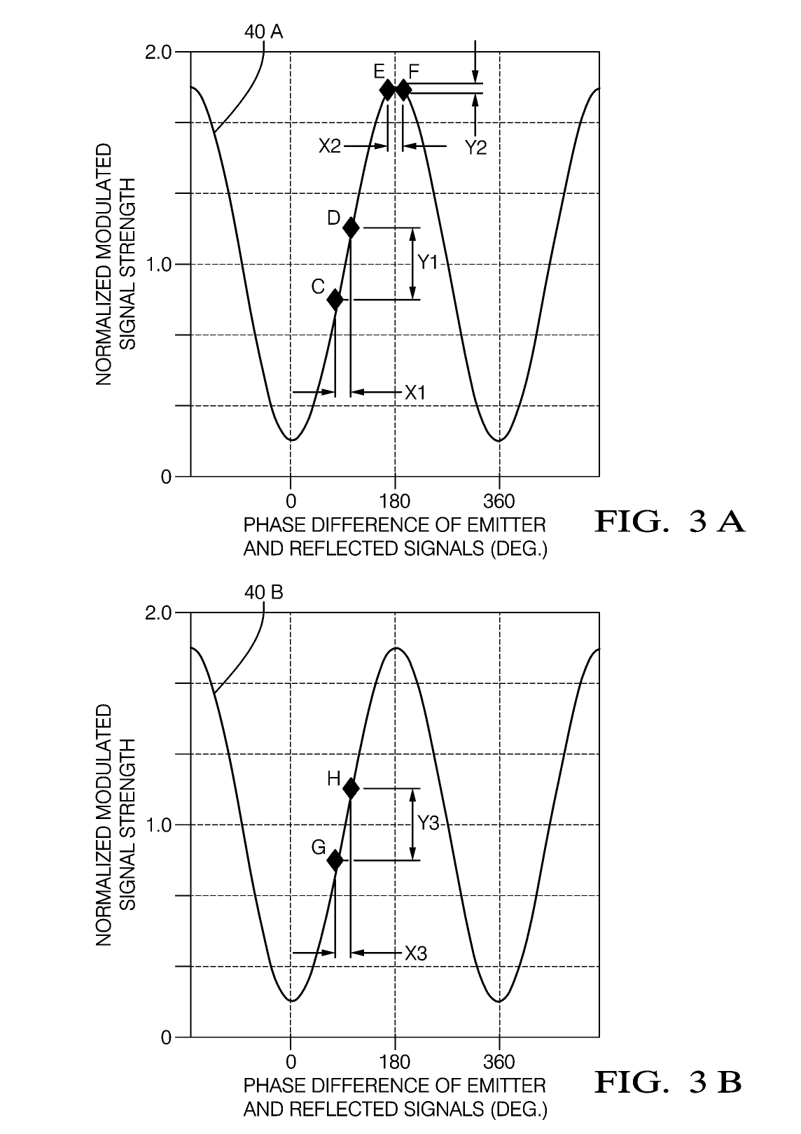

At step 416, if the first motion signal magnitude is less than the first threshold, then a second emitted signal is emitted at step 418. The second emitted signal has a second wavelength different from a first wavelength associated with the first emitted signal. The second wavelength is selected to increase the motion signal magnitude as will be described in greater detail below with regard to FIG. 3.

At step 418, controller 12 outputs an excitation signal to emitter 14 to generate a second emitted signal 22. The excitation signal is preferably sinusoidal and electric, and emitted signal 22 is preferably an ultrasonic acoustic sound wave having a second wavelength. Emitted signal 22 propagates toward infant 20 and is reflected by infant 20 to generate reflected signal 24 that propagates distance 39 toward detector 16. At step 420, reflected signal 24 is detected by detector 16. In response to reflected signal 24, detector 16 outputs an electrical detection signal to controller 12. At step 422, a second motion signal is determined based on a phase difference between the excitation signal and the detection signal. The value of the second motion signal depends upon the sum of distance 37 traveled by emitted signal 22 and distance 39 traveled by reflected signal 24. At step 424, a second motion signal magnitude based on an amount of variation or change in the second motion signal value is compared to a second threshold. If the motion signal magnitude is not less than the second threshold, i.e. greater than a second threshold, then the second motion signal may have sufficient magnitude to be useful for determining the presence of an occupant as indicated by the NO path going to step 426. The value of the second threshold is determined experimentally since it is dependent upon a number of factors such as the dimensions of the vehicle interior, materials used in the vehicle interior, and various operational characteristics of transducer 28. At step 424, if the second motion signal magnitude is less than the second threshold, then the first emitted signal is emitted at step 410.

Alternately, if the second motion signal magnitude is less than the second threshold, a third emitted signal having a third wavelength different from the first wavelength and the second wavelength may be emitted. The second threshold may alternately be selected so that the first motion signal and the second motion signal may in combination provide a sufficient degree of confidence. Thus, the first motion signal and the second motion signal may be utilized individually, or may be combined or correlated to form a composite motion signal that may provide a sufficient degree of confidence for determining the presence of an occupant.

At step 426, the presence of an occupant is determined based on the first motion signal, the second motion signal, or a combination of the first motion signal and the second motion signal. The first and second motion signals may be analyzed to determine if the motion signal has a repetitive characteristic and if repetitive, determine a repetition frequency and determine if the frequency of the motion signal is indicative of a respiration pattern.

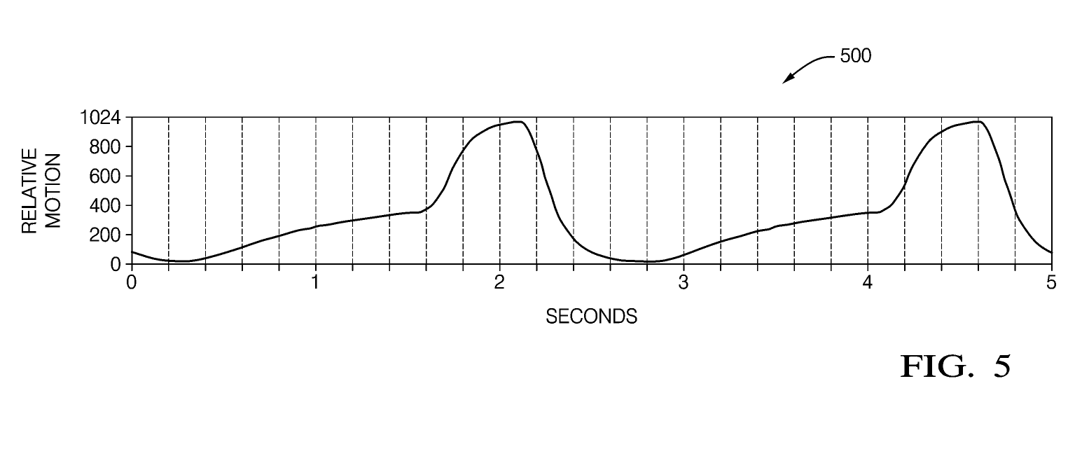

FIG. 5 shows an example of a motion signal 500 that corresponds to an infant respiration pattern. The respiration pattern has a period of about 2.5 seconds, corresponding to a respiration rate of about 24 breaths per minute. In comparison, respiration by an adult that is expected to be slower than respiration by an infant, and respiration by a pet such as a dog is expected to be faster than respiration by an infant. Controller 12 may be further adapted analyze a motion signal to determine if the motion signal has a rhythmic characteristic and determine if the rhythmic characteristic corresponds to a respiration pattern, particularly an infant respiration pattern. Alternately, a motion signal may be compared to the shape of a predetermined respiration pattern shape. For example the rise time and fall times of a respiration pattern may be different. As such, a motion signal having similarly different rise time and fall time characteristics may be indicative of respiration. If the detected motion is indicative of respiration by an infant, the system and method may be also be configured to determine that the infant is alone in the vehicle, that the vehicle is parked, that the vehicle doors locked, and take some remedial action such as unlocking the doors, rolling the windows down, or sounding the horn.

U.S. Pat. Nos. 6,932,769 and 7,473,228 describe motion detection methods, and are hereby incorporated herein by reference. While not limited to any particular theory, as used herein, an acoustic phase difference refers to the phase difference of a phase of reflected signal 24 at detector 16 relative to a phase of emitted signal 22 at emitter 14. A change in the acoustic phase difference is a function of a change in signal travel distance 36 which is equal to distance 37 plus distance 39. If an object such as infant 20 moves such that the signal travel distance 36 changes, there is a corresponding change in the acoustic phase difference. Alternately, the transducer 28 could be physically moved to affect a change in the acoustic phase difference. This causes a corresponding change in a phase difference of a phase of the detection signal received by controller 12 relative to a phase of the excitation signal output by controller 12. Controller 12 is adapted to combine the excitation signal with the detection signal to generate a modulated signal. The combining of the excitation signal with the detection signal is preferably by adding. The amplitude of the modulated signal is dependent on the phase difference. The modulated signal is then amplitude demodulated using the excitation signal as a demodulation carrier to generate a motion signal based upon the demodulated signal. The motion signal has a value that varies in response to the signal received by detector 16 and corresponds to movement of anything that reflects emitted signal 22 to generate reflected signal 24. In the absence of motion, the phase difference is constant, so the value of the motion signal is constant. When motion occurs, the amplitude of the modulated signal changes leading to a corresponding change of the value of the motion signal. Thus, change in the value of the motion signal is indicative of motion by an occupant.

FIG. 3A illustrates a waveform 40A that depicts a relationship between a PHASE DIFFERENCE OF EMITTED AND REFLECTED SIGNALS at the transducer 28 and a NORMALIZED MODULATED SIGNAL STRENGTH generated by the controller 12 and arising from emitting a first emitted signal having a first wavelength. The PHASE DIFFERENCE OF EMITTED AND REFLECTED SIGNALS corresponds to the phase difference of the first emitted signal and the first reflected signal at the transducer 28. The NORMALIZED MODULATED SIGNAL STRENGTH corresponds to the amplitude of the modulated signal arising from the addition of the excitation signal and the detection signal. The scaling of the NORMALIZED MODULATED SIGNAL STRENGTH is selected for purposes of illustration. In controller 12, a modulated signal strength may be a binary number suitable for processing by controller 12. A change in the phase difference corresponds to a movement by an occupant reflecting emitted signal 22. The change in the phase difference can be plotted on the waveform 40A by indicating a beginning point and an end point of the movement.

As an occupant or object moves from the beginning point to the end point, the movement can be tracked by moving correspondingly along waveform 40A. If an object does not move, the signal travel distance 36 does not change so the phase difference is constant. Preferably, controller 12 processes the excitation signal and the detection signal such that the value of the modulated signal is always greater than zero, as illustrated in FIGS. 3A and 3B. Alternately, the signals could be processed such that the transformation waveform was centered about zero and the modulated signal strength value would have positive and negative values.

By way of an example, a movement by an occupant from position C to position D is illustrated by indicating a beginning phase difference at point C and an ending phase difference at point D. Such a movement may arise from an infant inhaling. In this example, a movement distance X1 changes the phase difference changes by about 25 degrees. Accordingly, the amplitude of the modulated signal changes by about 0.4 and generates a corresponding first motion signal magnitude Y1. For this example, a first threshold of 0.1 is selected. As such, the first motion signal magnitude Y1 is greater than the first threshold, so the controller 12 can determine the presence of an occupant based on the first motion signal. By way of further example, a movement having a movement distance X2 equal to X1 is indicated as beginning at point E and ending at point F. For this example, the signal travel distance 36 is nominally different by one quarter wavelength of the first emitted signal. For this example, the motion signal magnitude is less than 0.1, therefore less the first threshold, so controller 12 may not determine the presence of an occupant.

FIG. 3B illustrates a waveform 40B that depicts a relationship between a PHASE DIFFERENCE OF EMITTED AND REFLECTED SIGNALS and a NORMALIZED MODULATED SIGNAL STRENGTH for a second emitted signal having a second wavelength different from the first wavelength. In this example, a movement by an occupant from position G to position H is illustrated by indicating a beginning phase difference at point G and an ending phase difference at point H. In this example, position G corresponds to position E, position H corresponds to position F and movement distance X3 is equal to X2. The second wavelength was selected to increase the second motion signal magnitude. Thus, the motion signal arising from a second emitted signal at a second wavelength detecting an occupant at the same positions now generates a second motion signal magnitude that can be used to determine the presence of an occupant.

In this example, the difference in wavelength of the first emitted signal and second emitted signal changes the total number of wavelengths occurring over the signal travel distance 36 is by one-quarter of a wavelength. The effect of such a change sifts the nominal phase difference by about 90 degrees, from between points E and F to between points G and H. The relationship between increasing or decreasing the number of wavelengths, and the direction that an indicated position shifts when indicated by points on waveform 40A and 40B, depends on whether the combining of the excitation signal and the detection signal is by way of addition or subtraction, and if subtracted, which signal is the minuend and which signal is the subtrahend. It is noted that a second emitted signal that leads to placing points G and H on transformation waveform 40B to have a nominal phase difference of 270 degrees would similarly increase the amplitude modulation change from Y2 to Y3. For the purposes of this exemplary discussion, the signal processing will be such that a second emitted signal having a frequency greater than the first emitted signal will cause a point corresponding to a position on transformation waveform 40A to be placed to the left on 40B, thus decreasing the phase difference of corresponding points.

Alternately, the wavelength of the second emitted signal could be appropriately increased to decrease the number of wavelengths by one quarter wavelength, thereby determining the nominal phase difference of points G and H to be centered about 270 degrees, and thus achieve the same increased change in motion signal magnitude indicated by Y1. It is noted that the modulated signal strength will not distinguish moving the nominal phase difference to +90 degrees from moving to −270 degrees. Furthermore, the modulated signal will not distinguish a specific phase difference shift from that specific phase difference shift plus or minus integer multiples of 180 degrees (i.e.—Phase difference shift=90°±/−n*180°, n=0, 1, 2, 3 . . . ). Therefore, any consideration of a specific phase difference shift of 0 to 360 degrees of phase difference includes a consideration of shifting that specific phase difference plus or minus any integer multiple of 180 degrees of phase difference. Also, a change in modulated signal amplitude may be positive or negative. However, for comparing motion signal magnitudes such as Y2 and Y3, absolute values are assumed.

Selecting a second wavelength to increase the change in modulated signal strength may consider past frequencies and the motion signals for these past frequencies. By examining the prior changes in motion signal, it can be determined if an increase in motion signal change has been realized by changing the frequency, and if there is a trend in the motion signal that suggests some optimal frequency for maximizing the motion signal change. The change in wavelength from the first wavelength to the second wavelength needs to be large enough to be likely to improve motion detection, but not so large as to provide no improvement, such as would occur if the phase difference shift was 180 degrees. However, if the motion detector 30 has the means to make a distance measurement, even if imprecise, the new frequency may be more optimally selected. Thus, the selection of a second wavelength may be based on the first wavelength and a distance based on an emitted signal travel distance and a reflected signal travel distance. Based on these considerations, for occupant detection in a vehicle, a range of phase difference shifts is 40 degrees to 140 degrees or −40 degrees to −140 degrees is suggested. A phase difference shift less than 40 degrees, i.e. within +/−40 degrees, may not sufficiently increase the second motion signal magnitude. A +/−180 degree phase difference shift would not increase the second motion signal magnitude. As such, a phase difference shift greater than 140 degrees, i.e. outside of +/−140 degrees, may also not sufficiently increase the second motion signal magnitude.

Thus, a method and system for detecting an infant by detecting respiration by the infant is provided. Detection is improved by changing the frequency and thus the wavelength of the ultrasonic signal used to detect motion to improve detection of small movements such as movements associated with respiration. Furthermore, the movement is analyzed to determine if the motion is indicative of respiration movement. If the motion is indicative of respiration by an infant, the vehicle may be configured to respond in a way that protects the infant from being injured, such as may occur if the infant were inadvertently locked into a closed-up automobile on a hot sunny day.

While this invention has been described in terms of the preferred embodiments thereof, it is not intended to be so limited, but rather only to the extent set forth in the claims that follow.

We claim:

1. A method for detecting an occupant in a vehicle comprising the steps of:
emitting a first emitted signal having a first wavelength;
detecting a first reflected signal based on the first emitted signal, wherein the first reflected signal has a first phase difference with respect to the first emitted signal;
determining a first motion signal based on the first phase difference, said first motion signal having a first motion signal magnitude;
if the first motion signal magnitude is greater than a first threshold, determining the presence of an occupant based on the first motion signal;
if the first motion signal magnitude is less than the first threshold, emitting a second emitted signal having a second wavelength,
detecting a second reflected signal based on the second emitted signal, wherein the second reflected signal has a second phase difference with respect to the second emitted signal;
determining a second motion signal based on the second phase difference, said second motion signal having a second motion signal magnitude; and
if the second motion signal magnitude is greater than a second threshold, determining the presence of an occupant based on the second motion signal.

2. The method in accordance with claim 1, wherein the second wavelength is selected base on the first wavelength and a transducer to occupant distance.

3. The method in accordance with claim 1, wherein the second emitted signal is effective to produce a phase difference shift in the second phase difference relative to the first phase difference of about 40 to about 140 degrees or about −40 to about −140 degrees.

4. The method in accordance with claim 1, wherein the method is adapted for detecting an infant seated in an infant seat secured to a vehicle seat of a vehicle, and further wherein the method is adapted for detecting respiration of the infant.

5. The method in accordance with claim 4, the step of determining the presence of the occupant includes detecting a respiration pattern based upon the first motion signal and the second motion signal.

6. The method in accordance with claim 1, wherein the first emitted signal and the second emitted signal are emitted by a emitter located a first distance from the occupant, wherein the first reflected signal and the second reflected signal are detected by a detector located a second distance from the occupant, and wherein the second wavelength is based on the first wavelength and a signal travel distance equal to the first distance and the second distance.

7. The method in accordance with claim 1, wherein the steps of emitting the first emitted signal and the second emitted signal and the steps of detecting the first reflected signal and the second reflected signal are performed by an ultrasonic transducer.

8. The method in accordance with claim 7, wherein the method is adapted for detecting an infant in an infant seat secured in a vehicle seat, such that a signal travel distance corresponds to a distance traveled by the first emitted signal from the ultrasonic transducer to the infant and a distance traveled by the first reflected signal travels from the infant to the ultrasonic transducer, and wherein the second wavelength is based on the first wavelength and the signal travel distance.

9. The method in accordance with claim 1, wherein the step of determining the first motion signal includes amplitude demodulating the first reflected signal, and determining the second motion signal includes amplitude demodulating the second reflected signal.

10. The method in accordance with claim 1, wherein the second threshold is equal to the first threshold.

11. A method for detecting an occupant in a vehicle comprising the steps of:
emitting a first emitted signal having a first wavelength;
detecting a first reflected signal that is a reflection of the first emitted signal;
determining a first modulated signal based on a phase difference of the first reflected signal relative to the first emitted signal;
determining a first motion signal by amplitude demodulating the first modulated signal, said first motion signal having a first motion signal magnitude;
if the first motion signal magnitude is greater than or equal to a first threshold, determining the presence of an occupant based on the first motion signal;
if the first motion signal magnitude is less than the first threshold, selecting a second wavelength distinct from the first wavelength;
emitting a second emitted signal having the second wavelength;
detecting a second reflected signal that is a reflection of the second emitted signal;
determining a second modulated signal based on a second phase difference of the second reflected signal relative to the second emitted signal;
determining a second motion signal by amplitude demodulating the second modulated signal, said second motion signal having a second motion signal magnitude; and
if either the first motion signal magnitude or the second motion signal magnitude is greater than a second threshold, determining the presence of an occupant based on the first motion signal and the second motion signal,
wherein the step of selecting the second wavelength is effective to produce a second nominal phase difference based on the second modulated signal that differs about 40 to about 140 degrees or about −40 to about −140 degrees from a first nominal phase difference based on the first modulated signal.

12. A system for detecting an occupant in a vehicle comprising:
an emitter for emitting a signal;
a detector for detecting a reflected signal; and
a controller configured to output a first excitation to the emitter for emitting a first emitted signal having a first wavelength, receive a first detection signal from the detector for detecting a first reflected signal based on the first emitted signal, wherein the first reflected signal has a first phase difference with respect to the first emitted signal, determine a first motion signal based on the first phase difference, wherein said first motion signal has a first motion signal magnitude, wherein if the first motion signal magnitude is greater than a first threshold, determining the presence of an occupant, if the first motion signal magnitude is less than the first threshold, emitting a second emitted signal having a second wavelength, detecting a second reflected signal based on the second emitted signal, wherein the second reflected signal has a second phase difference with respect to the second emitted signal, determining a second motion signal based on the second phase difference, said second motion signal having a second motion signal magnitude, and if the second motion signal magnitude is greater than a second threshold, determining the presence of an occupant, wherein the second emitted signal is effective to produce a phase difference shift in the second phase difference relative to the first phase difference of about 40 to about 140 degrees or about −40 to about −140 degrees.

13. The system in accordance with claim 12, wherein said controller is further adapted to detect an infant seated in an infant seat secured to a vehicle seat of a vehicle, and detect respiration of the infant.

14. The system in accordance with claim 12, wherein said controller is further adapted to detect an occupant respiration pattern based upon the first motion signal and the second motion signal.

15. The system in accordance with claim 12, wherein the first emitted signal and the second emitted signal are emitted by a emitter located a first distance from the occupant, wherein the first reflected signal and the second reflected signal are detected by a detector located a second distance from the occupant, and wherein the second wavelength is based on the first wavelength and a signal travel distance equal to the first distance and the second distance.

16. A system in accordance with claim 12, wherein the emitter and the detector are combined into an ultrasonic transducer.

17. A system in accordance with claim 16, wherein a signal travel distance corresponds to a distance traveled by the first emitted signal from the ultrasonic transducer to the infant and a distance traveled by the first reflected signal travels from the infant to the ultrasonic transducer, and wherein the second wavelength is based on the first wavelength and the signal travel distance.

18. A system in accordance with claim 12, wherein the controller determines the first motion signal by amplitude demodulating the first reflected signal, and determines the second motion signal by amplitude demodulating the second reflected signal.

19. A system in accordance with claim 12, wherein the second threshold is equal to the first threshold.

20. A method for detecting an occupant in a vehicle having a transducer and a controller, said method comprising the steps of:
outputting a first excitation having a first frequency by the controller to the transducer to emit a first emitted signal;
receiving a first detection signal by the controller from the transducer to detect a first reflected signal based on the first emitted signal, wherein the first detection signal has a first phase difference with respect to the first excitation signal;
determining a first motion signal based on the first phase difference, said first motion signal having a first motion signal magnitude;
if the first motion signal magnitude is greater than a first threshold, determining the presence of an occupant based on the first motion signal;
if the first motion signal magnitude is less than the first threshold, outputting a second excitation signal to the transducer to emit a second emitted signal having a second frequency,
receiving a second detection signal from the transducer to detect a second reflected signal based on the second emitted signal, wherein the second reflected signal has a second phase difference with respect to the second emitted signal;
determining a second motion signal based on the second phase difference, said second motion signal having a second motion signal magnitude; and
if the second motion signal magnitude is greater than a second threshold, determining the presence of an occupant based on the second motion signal.

21. The method in accordance with claim 1, wherein the second frequency is selected base on the first frequency and a transducer to occupant distance.
